(19) United States
(12) Patent Application Publication
(10) Pub. No.: US 2006/0160934 A1
(43) Pub. Date: Jul. 20, 2006

(54) Heat curable composition comprising fluoropolyether

(75) Inventors: Hidenori Koshikawa, Annaka-shi (JP); Mikio Shiono, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/331,070

(22) Filed: Jan. 13, 2006

(30) Foreign Application Priority Data
Jan. 14, 2005 (JP) 2005-007516
Jan. 12, 2006 (JP) 2006-004795

(51) Int. Cl. B60C 1/00; C08K 3/10

(52) U.S. Cl. 524/261; 524/403; 524/492

(57) ABSTRACT

A composition comprising 100 parts by mass of (A) a linear fluoropolyether having at least two alkenyl groups, (B) a fluorine-containing organohydrogensiloxane having at least two SiH bonds in such an amount that an amount of the SiH bonds ranges from 0.5 to 3.0 moles per mole of the alkenyl group of the Component (A), (C) a platinum group metal compound in an amount of from 0.1 to 500 ppm calculated as the platinum group metal atom, and
1 to 50 parts by mass of (D) fumed silica having 350×10¹⁸/g or more of silanol groups on its surface. A cured product of the composition shows little migration.

### CROSS REFERENCES

This application claims benefits of the Japanese Patent Applications No. 2005-007516 filed on Jan. 14, 2005, and the Japanese Patent Applications No. 2006-004795 filed on Jan. 12, 2006, the contents of which are hereby incorporated by reference.

### BACKGROUND OF THE INVENTION

1. Technical Field

The present invention relates to a heat curable composition comprising a fluoropolyether, particularly, to a composition comprising a specific silica whereby migration from a cured product of the composition to an object being in contact with the cured product is significantly reduced.

The present invention relates also to a method to prevent migration from a cured product of a heat curable composition comprising a fluoropolyether by incorporating a specific silica to the fluoropolyether.

2. Prior Art

Japanese Patent Application Laid-Open No. 9-95615 and No. 8-199070 disclose a composition comprising a linear perfluoropolyether compound having at least two alkenyl groups in a molecule, an organic silicon compound having at least two H—SiOSiO moieties in a molecule, and a platinum catalyst. The composition gives a cured product by hydrosilylation reaction, which product has excellent resistance to solvents, chemicals, and heat, excellent low temperature properties, low moisture permeability and electrical properties.

However, when the cured product is brought into contact with a n object such as silicon wafer, metal plate or plastic film, fluorine-containing substances migrate from the cured product to the object surface to contaminate it.

For example, when a flexible printed circuit board, hereinafter referred to as FPC, is transferred in its production line on a surface of a belt made of the cured product, fluorine-containing substances migrate to the FPC, causing defective electronic contact between the FPC and electronic parts soldered on the FPC.

Most of the migrated substances are probably residual linear perfluoropolyether compounds which left unreacted in the cured product.

### SUMMARY OF THE INVENTION

An object of the present invention is to provide a composition which gives a cured product showing little migration to an object such an a silicon wafer being contact with the cured product

The present inventors have found that the above object can be attained by incorporating specific fumed silica in the composition.

The present invention is a composition comprising

100 parts by mass of (A) a linear fluoropolyether having at least two alkenyl groups,

(B) a fluorine-containing organohydrogensiloxane having at least two SiH bonds in such an amount that an amount of the SiH bonds ranges from 0.5 to 3.0 moles per mole of the alkenyl group of the Component (A),

(C) a platinum group metal compound in an amount of from 0.1 to 500 ppm calculated as the platinum group metal atom, and

1 to 50 parts by mass of (D) fumed silica having 350×10¹⁸/g or more of silanol groups on its surface.

Another aspect of the present invention is a method for preventing migration of a substance from a cured product of a composition to an object in contact with the cured product, wherein the composition comprises

(A) a linear fluoropolyether having at least two alkenyl groups,

(B) a fluorine-containing organohydrogensiloxane having at least two SiH bonds, and

(C) a platinum group metal compound

and said substance originates from the composition,

, said method comprising the step of blending 1 to 50 parts by mass of (D) fumed silica having 350×10¹⁸/g or more of silanol groups on its surface with 100 parts by mass of Component (A).

### DESCRIPTIONS OF PREFERRED EMBODIMENTS

Each component of the present composition will be explained in details below.

Component (A)

Component (A) is a linear fluoropolyether having at least two alkenyl groups and a divalent fluoropolyether moiety in its backbone.

Preferably, the alkenyl group in the linear fluoropolyether (A) has 2 to 8, particularly 2 to 6, carbon atoms and a CH₂═CH— moiety at an end. Examples of the alkenyl group include vinyl, allyl, propenyl, isopropenyl, butenyl, and hexenyl groups, among which vinyl and allyl groups are preferred.

Preferred linear fluoropolyether (A) is represented by the following formula (2):
CH₂═CH—(X)ₚ—(CF(CF₃)—CF₂—O)_{q}—(X′)ₚ—CH═CH₂ (2)
wherein X is selected from the group consisting of the following moieties: —CH₂—, —CH₂O—, —CH₂OCH₂—, and —Y—NR—CO—, wherein Y is selected from the group consisting of —CH₂—, o-, m-, and p-dimethylsilylphenylene moieties represented by the following formula (3), 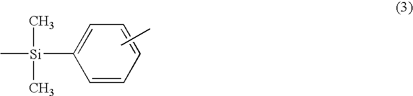
R is a hydrogen atom or substituted or unsubstituted monovalent hydrocarbon group;
X′ is selected from the group consisting of the following moieties:
—CH₂—, —OCH₂—, —CH₂OCH₂— and —CO—NR—Y′—, wherein Y′ is selected from the group consisting of —CH₂—, o-, m-, and p-dimethylsilylphenylene moieties represented by the following formula (4), 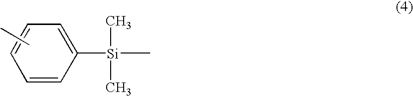
R is as defined above, p is 0 or 1, and q is an integer of from 0 to 400.

Preferred examples of R include, besides a hydrogen atom, hydrocarbon groups having 1 to 12, particularly 1 to 10, carbon atoms, for example, alkyl groups such as methyl, ethyl, propyl, butyl, hexyl, octyl, cyclohexyl groups; aryl groups such as phenyl and tolyl groups; aralkyl groups such as benzyl and phenetyl groups, and partly or fully halogenated groups thereof. Among these, hydrogen atom, methyl, phenyl and aryl groups are more preferred.

Preferably, the linear fluoropolyether (A) is represented by the following formula:

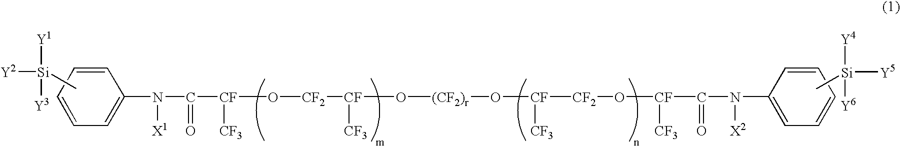

wherein each of X¹ and X² is a hydrogen atom, methyl, phenyl or aryl group; Y¹, Y², Y³, Y⁴, Y⁵, and Y⁶, which may be different from each other, are substituted or unsubstituted hydrocarbon groups, at least two of the hydrocarbon groups being alkenyl groups; r is an integer of from 2 to 6, and each of m and n is an integer of from 0 to 200.

Examples of the alkenyl groups are as described above. Preferred substituted or unsubstituted hydrocarbon group has 1 to 12, particularly 1 to 10, carbon atoms. Examples of the hydrocarbon group include alkyl groups such as methyl, ethyl, propyl, butyl, hexyl, octyl, cyclohexyl groups; aryl groups such as phenyl and tolyl groups; aralkyl groups such as benzyl and phenetyl groups, and partly or fully halogenated groups thereof, among which methyl and ethyl groups are preferred.

The linear fluoropolyether (A) preferably has an alkenyl group content of from 0.002 to 0.3 mol/100 g, more preferably from 0.008 to 0.12 mol/100 g. If it has alkenyl groups less than the aforesaid lower limit, it may give a cured product having too low degree of crosslinkage. If it has alkenyl groups above the aforesaid upper limit, it may give a cured product which lacks desirable mechanical properties as an elastic rubber.

Examples of the linear fluoropolyether (A) represented by the formula (1) are as shown below, wherein Me represents a methyl group and Ph represents a phenyl group. 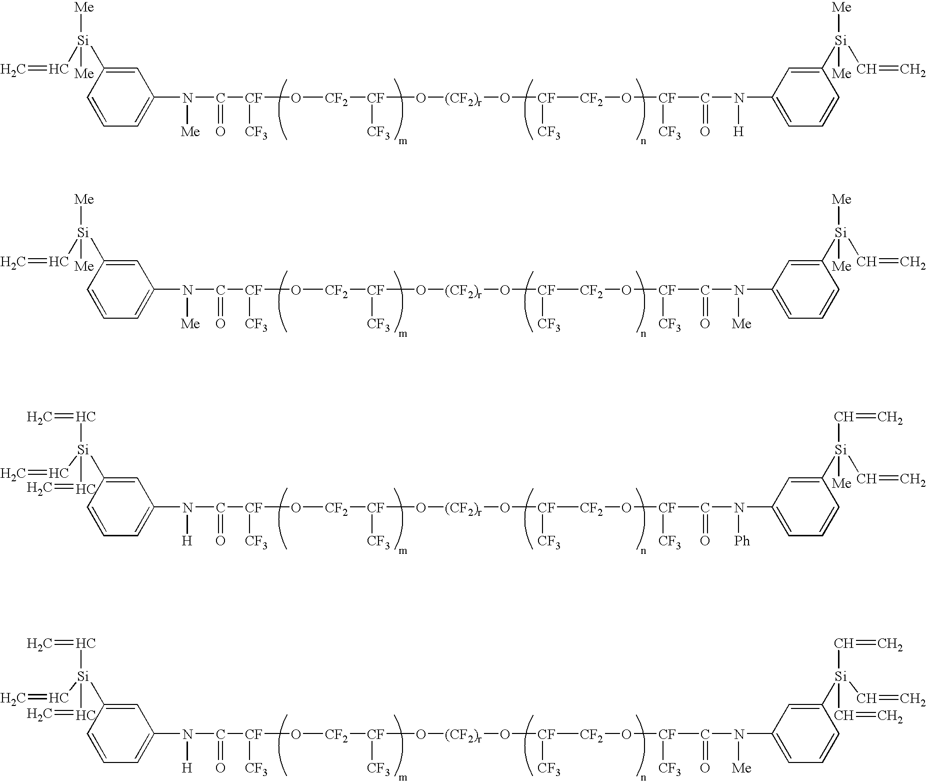
wherein m, n and r are as defined above.

These linear fluoropolyethers may used alone or in a mixture of two or more of them.

The linear fluoropolyether (A) has a viscosity at 23° C., measured according to the Japanese Industrial Standard K6249, preferably of from 100 to 100,000 mPa·s, more preferably from 500 to 50,000 mPa·s, most preferably from 1,000 to 20,000 mPa·s, because of good physical properties of both composition and cured product used in sealing, potting, coating or impregnating applications.

Component (B)

Component (B) is a fluorine-containing organohydrogensiloxane having at least two SiH bonds. It functions as a crosslinker or chain extender for Component (A).

Component (B) preferably has at least one fluorine-containing group such as perfluoroalkyl, perfluorooxyalkyl, perfluoroalkylene, and perfluorooxyalkylene groups because of good compatibility with and dispersion in Component (A), and hence good homogeneity of a cured product.

Examples of the fluorine-containing group of Component (B) are as follows:
CₖF₂ₖ₊₁—
wherein k is an integer of from 1 to 20, preferably from 2 to 10;
—C_{g}F_{2g}—
wherein g is an integer of from 1 to 20, preferably from 2 to 10; 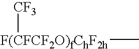
wherein f is an integer of from 2 to 200, preferably from 2 to 100 and h is an integer of from 1 to 3; 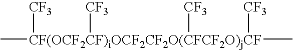
wherein i and j each is an integer of 1 or larger with an average of a total of i and j ranging from 2 to 200, preferably from 2 to 100;
—(CF₂O)ₗ—(CF₂CF₂O)ₛ—CF₂—

wherein l and s each is an integer of from 1 to 50.

A divalent linkage group between a silicon atom and the fluorine-containing group may be an alkylene, arylene, alkarylene, or arylalkylene group, which may have an ether, amide, or carbonyl group. Particularly preferred linkage group is represented by the following formula (5):
—(CH₂)ₜ—X″— (5)

wherein X″ is —OCH₂— or —Y″—NR′—CO—, wherein Y″ is selected from the group consisting of the following moieties, —CH₂—, o-, m-, and p-dimethylsilylphenylene groups represented by the following formula (6): 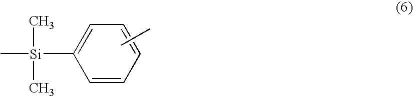
R′ is a hydrogen atom, substituted or unsubstituted hydrocarbon group, t is an integer of from 1 to 10, preferably from 1 to 5.

Examples of Component (B) include the following compounds, wherein Me represents a methyl group and Ph represents a phenyl group. These compound may be used alone or a mixture of two or more of them.

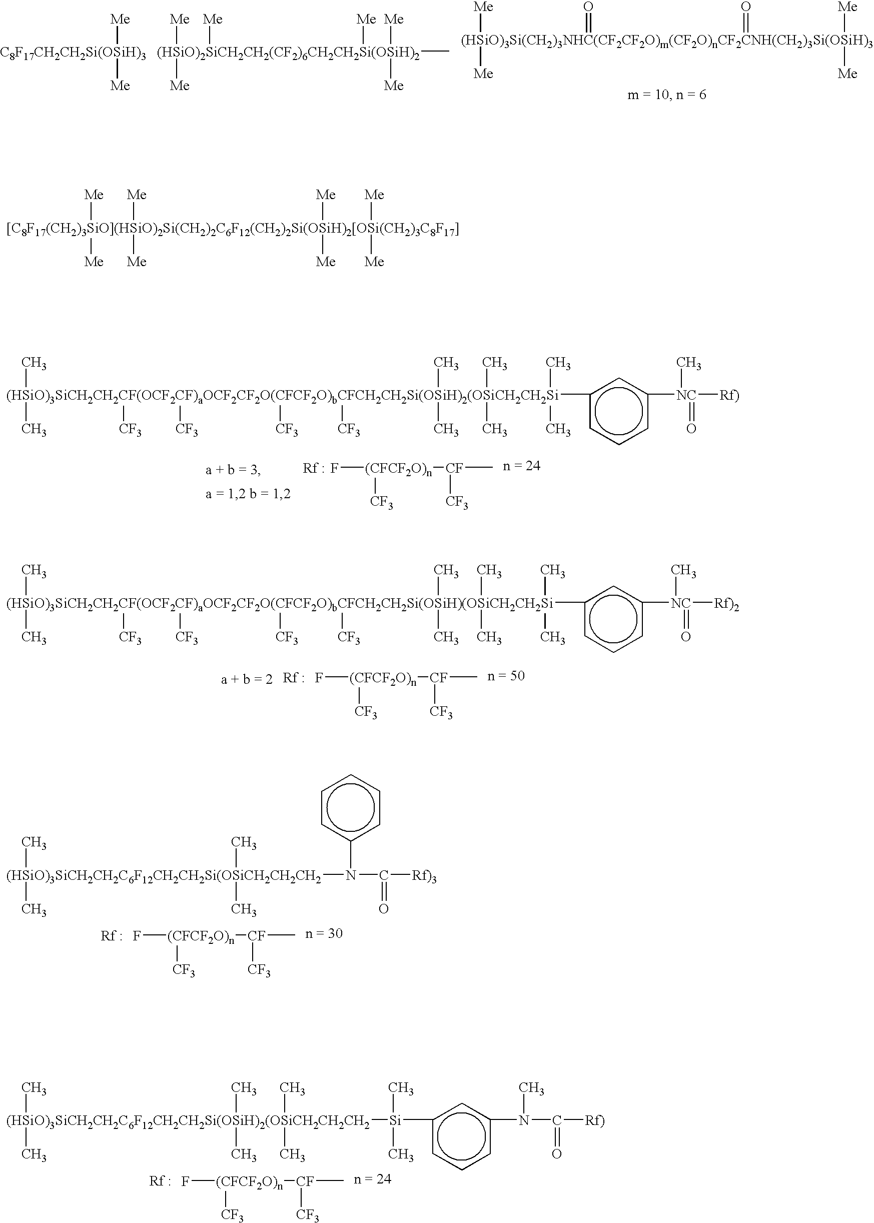

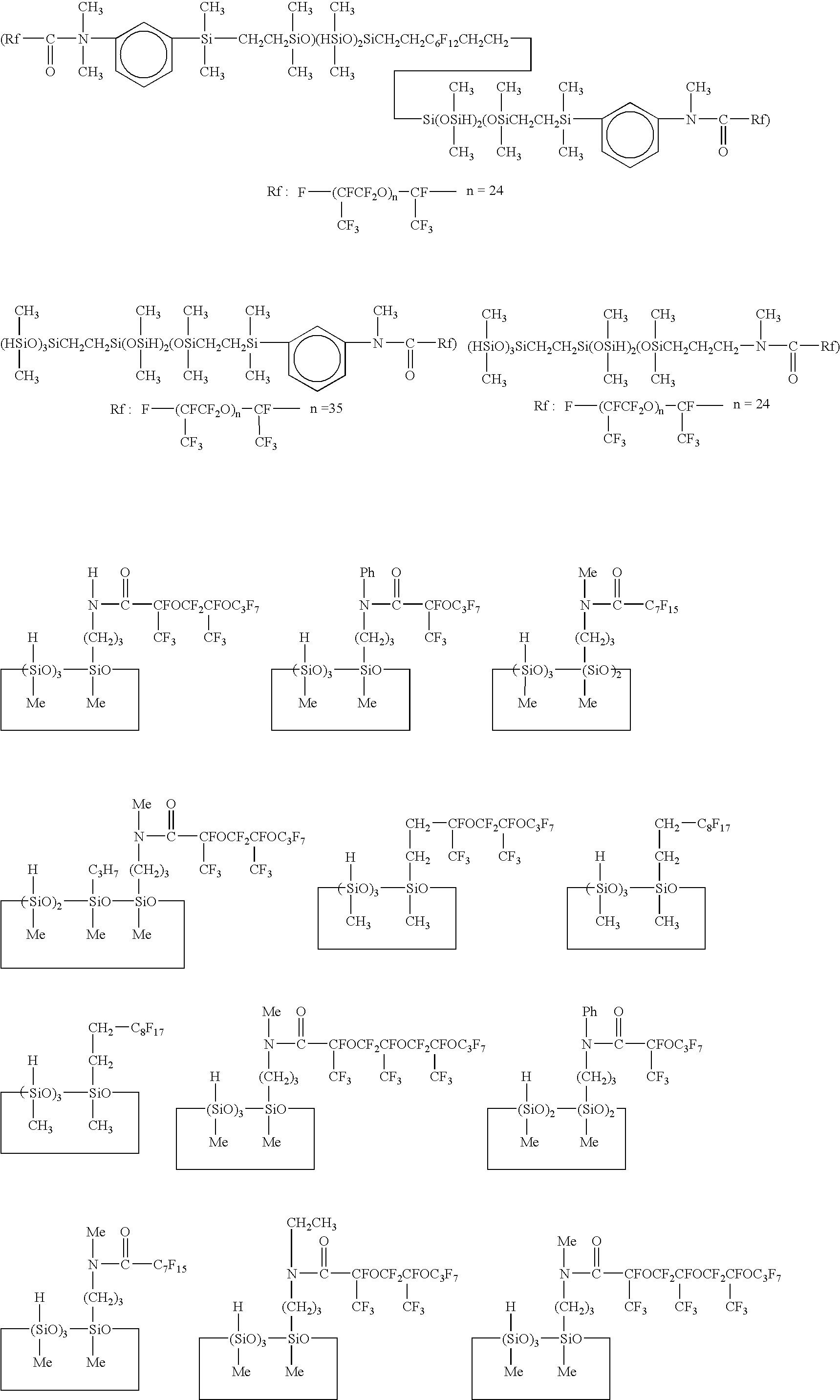

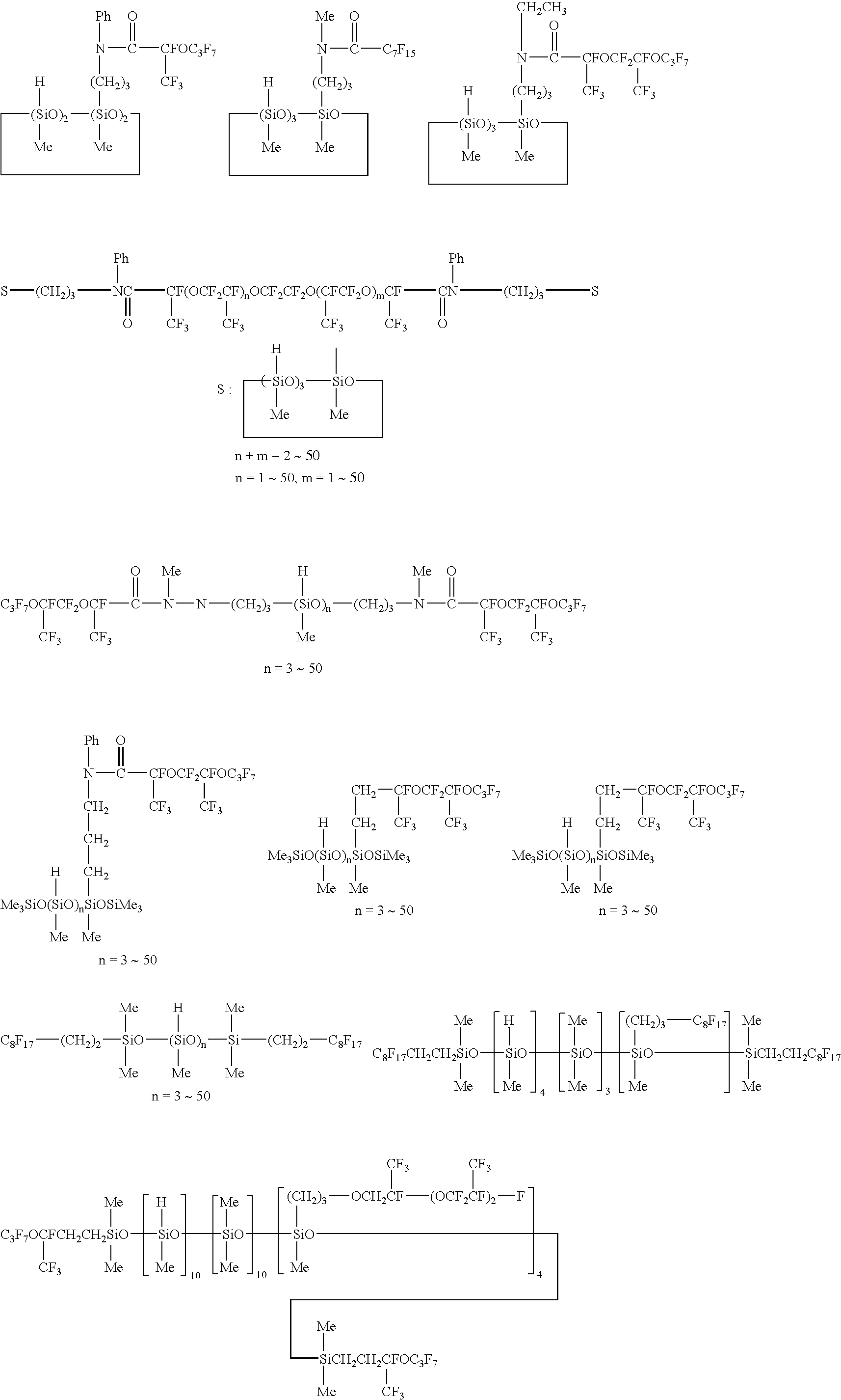

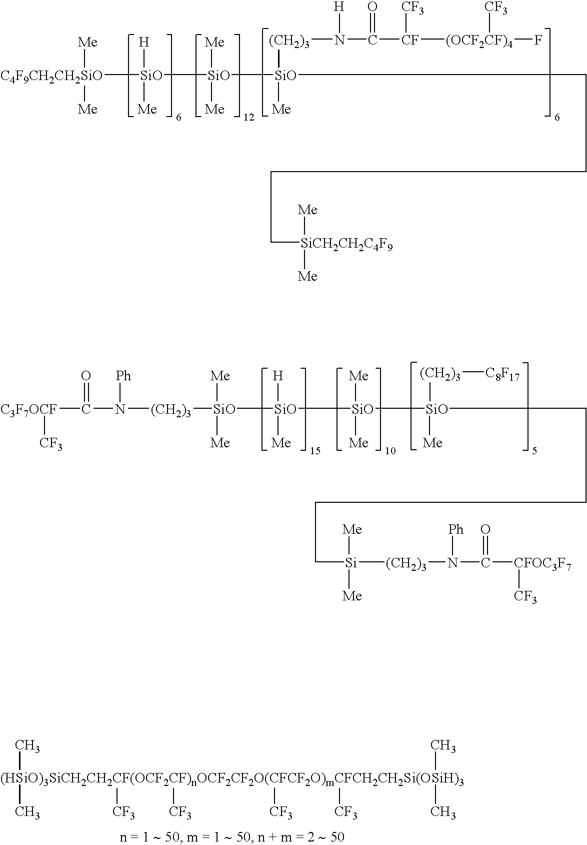

Component (B) is incorporated in the composition in an amount enough to cure Component (A). Typically, the amount is such that an amount of the SiH group of Component (B) per mole of alkenyl group of Component (A) ranges from 0.5 to 3.0 moles, preferably from 0.8 to 2.0 moles. A composition containing SiH group less than the aforesaid lower limit, a degree of crosslinkage may be too low to form a hardened product. A composition containing SiH group above the aforesaid upper limit may foam during a curing process.

Component (C)

Component (C) is a platinum group metal compound which catalyses an addition of the SiH groups of Component (B) to the alkenyl groups of Component (A). Platinum compounds are commonly used because of their relatively low price compared with other noble metal compounds.

Examples of the platinum compound include chloroplatinic acid, a complex of chloroplatinic acid with an olefin such as ethylene, an alcohol, or a vinylsiloxane, and platinum metal deposited on silica, alumina or carbon. Examples of the platinum group metal compound other than platinum compounds includes RhCl(PPh₃)₃, RhCl(CO)(PPh₃)₂, Ru₃(CO)₁₂, IrCl(CO)(PPh₃)₂, and Pd(PPh₃)₄, wherein Ph represents a phenyl group.

The catalyst may be used in a solid from but, preferably, it is used in a solution form dissolved in an appropriate solvent miscible with Component (A).

Component (C) may be used in a catalytic amount, typically, of from 1 to 500 ppm as platinum group metal per 100 parts by mass of Component (A).

Component (D)

Component (D) is fumed silica having 350×10¹⁸ or more of silanol groups on its surface. Generally, when silica is to be incorporated in an organic composition, its surface is treated to be hydrophobic to have reduced silanol groups. This is because the silanol groups increase viscosity of organic resins, making it difficult to prepare a homogeneous composition even by hot kneading. An inhomogeneous composition tends to give an inhomogeneous cured product having unsatisfactory mechanical properties. Surprisingly, the silica having 350×10¹⁸ or more of silanol groups prevents migration rather than adversely affects the mechanical properties.

The amount of silanol group per one gram of silica is calculated according the following equation (7):
Amount of silanol group (number/g)=BET specific surface area of the silica (m²/g)×The number of silanol group per surface area of the silica (number/nm²)

In the equation (7), the number of silanol group per surface area of the silica can be quantitated by several methods. Typical methods include a method of determining an amount of hydrogen generated in a reaction of well-dried silica with lithium aluminum hydride or a Grignard reagent and the Sears method using neutralization titration.

Preferably, the amount of silanol group (number/g) is 400×10¹⁸ or more, more preferably 500×10¹⁸ or more. The silica having 350×10¹⁸ or more of silanol group can prevent the migration without damaging mechanical properties of a cured product. It should be noted that fumed silica having silanol groups less than 350×10¹⁸ may be used in a mixture with other fumed silica having more than 350×10¹⁸ of silanol group, so that the mixture has 350×10¹⁸ or more of silanol groups as a whole. There is no upper limit for the amount of silanol, but about 800×10¹⁸/g is the available upper limit.

Preferably, the fumed silica has a BET specific surface area of from 100 m²/g to 400 m²/g.

Examples of the fumed silica having 350×10¹⁸ or more of silanol group include Aerosil A-200 and A-300, both available from Japan Aerosil Co. Ltd.

Component (D) is incorporated in the composition in an amount of from 1 to 50 parts by mass, preferably 2 to 25 parts by mass, per 100 parts by mass of Component (A). Component (D) less than the aforesaid lower limit may not reduce the migration satisfactorily. In contrast, Component (D) more than the aforesaid upper limit may give a composition having bad fluidity, so that a cured product thereof may have poor physical strength.

Optional Components

In addition to the aforesaid components, the present composition may contain various kinds of additives. Particularly, when the composition is to be used as an adhesive, it preferably contain, as an adhesive promoter, (E) an organosiloxane having at least one SiH group and at least one group selected form epoxy group and trialkoxysilyl groups. The epoxy and/or trialkoxysilyl group is bonded to a silicon atom of the organosiloxane through an organic group which may have an oxygen atom.

Preferably, the organosiloxane (E) has at least one perfluoroalkyl or perfluorooxyalyl group bonded to a silicon atom an organic group which may have an oxygen atom.

The organosiloxane (E) may be cyclic, linear, branched or a combination thereof. Examples of the organosiloxane (E) are as shown below. 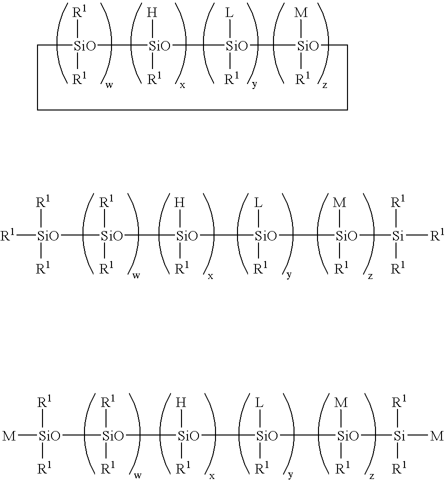
wherein R¹ is substituted or unsubstituted monovalent hydrocarbon group, w and z each is an integer of from 0 to 50, preferably from 0 to 20, x and y each is an integer of from 1 to 50, preferably from 1 to 20, with a total of w, x, y and z are such that a weight average molecular weight of the organosiloxane ranges from 2000 to 20000.

Preferably, R¹ has 1 to 10, particularly 1 to 8, carbon atoms. Examples of R¹ include alkyl groups such as methyl, ethyl, propyl, butyl, hexyl, cyclohexyl, and octyl groups; aryl groups such as phenyl and tolyl groups; aralkyl groups such as benzyl, and phenylethyl groups; and partly or fully halogenated groups thereof, among which methyl group is preferred.

L is an epoxy group, trialkoxysilyl group or a combination thereof bonded to a silicon atom through an organic group which may have an oxygen atom. Examples of L are as shown below.

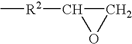

wherein R² is a divalent hydrocarbon group, which may have an oxygen atom, having 1 to 10, preferably 1 to 5 carbon atoms, for example, methylene, ethylene, propylene, butylene, hexylene, cyclohexylene, and octylene group;
—R³—Si(OR⁴)₃
wherein R³ is a divalent hydrocarbon group having 1 to 10, preferably 1 to 4, carbon atoms such as methylene, ethylene, propylene, butylene, hexylene, cyclohexylene, and octylene group, and R⁴ is a monovalent hydrocarbon group having 1 to 8, particularly 1 to 4, carbon atoms such as methyl, ethyl and n-propyl groups;

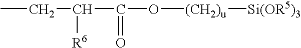

wherein R⁵ is a monovalent hydrocarbon group such as an alkyl group having 1 to 8, particularly 1 to 4, carbon atoms, R⁶ is a hydrogen atom or a methyl group, and u is an integer of from 2 to 10.

In the aforesaid formulae, M is preferably represented by the following formula (7):
-Z-Rf (7)

wherein Z is preferably represented by the above described formula (5).

Rf is a perfuluroalkyl or perfluorooxyalkyl group. Examples of Rf are as those described for Component (B), for example, the groups represented by the following formulae. 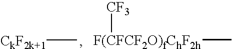
wherein k, f, and h are as defined above.

The organosiloxane (E) can be prepared by subjecting to an addition reaction in an ordinary manner an organohydrogen-polysiloxane having at least three SiH bonds, a compound having an aliphatic unsaturated bond such as a vinyl and allyl groups and an epoxy and/or trialkoxysilyl group and, optionally, a compound having an aliphatic unsaturated bond and a perfluoroalkyl or perfluorooxyalkyl group. In the reaction mixture, a total number of the aliphatic unsaturated bond should be smaller than that of SiH bonds. The organosiloxane (E) thus prepared is isolated from the reaction mixture, but just removing unreacted substances and catalyst from the reaction mixture may be enough.

Examples of the organosiloxane (E) are as shown below, wherein Me represents a methyl group and Ph represents a phenyl group. These compounds may be used alone or a mixture of two or more of them. 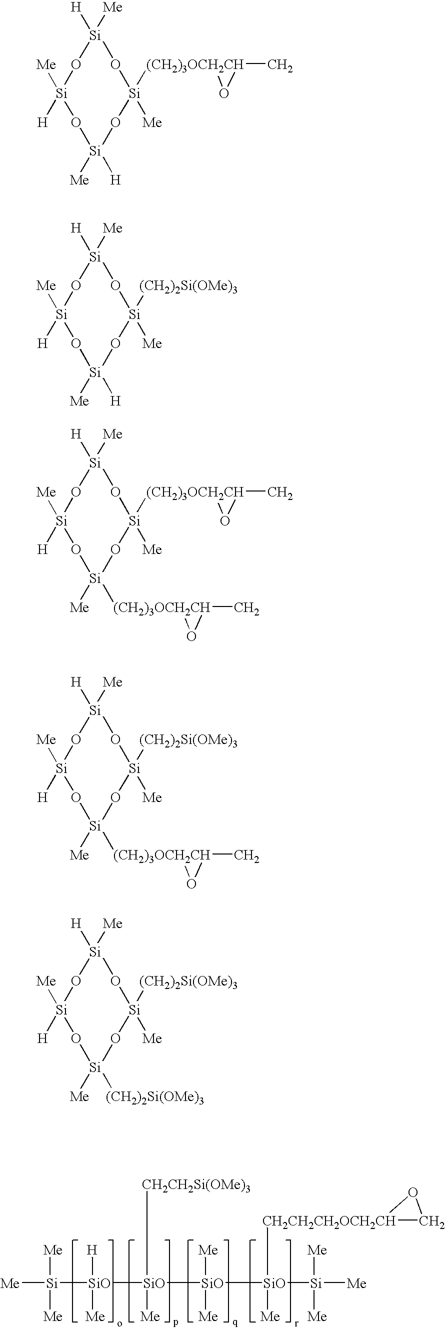
wherein o, q, r are positive integers and p is an integer of 0 or larger. 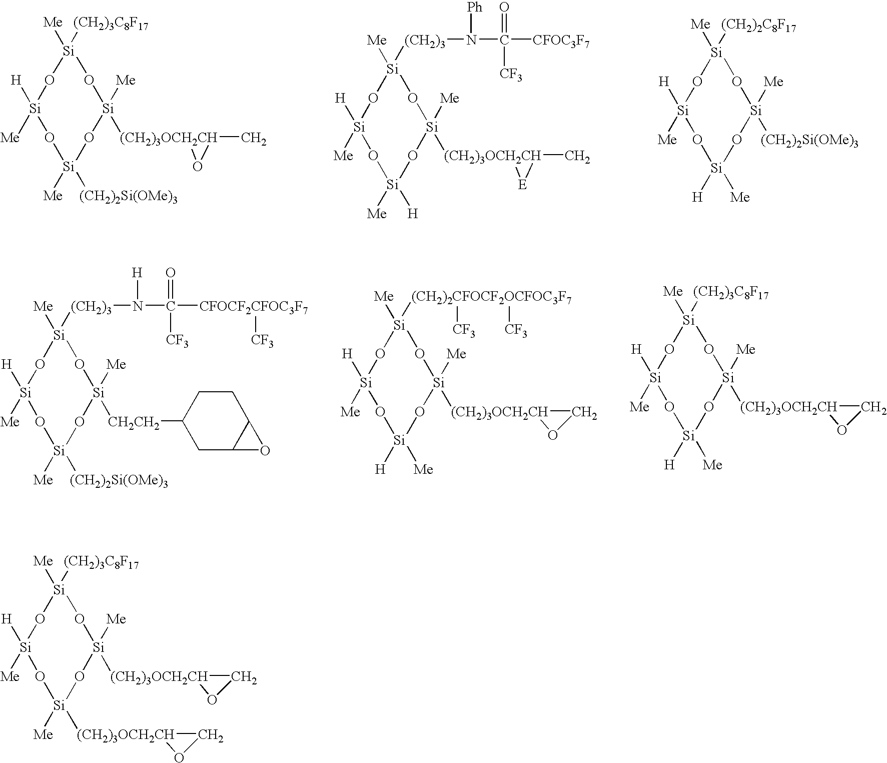 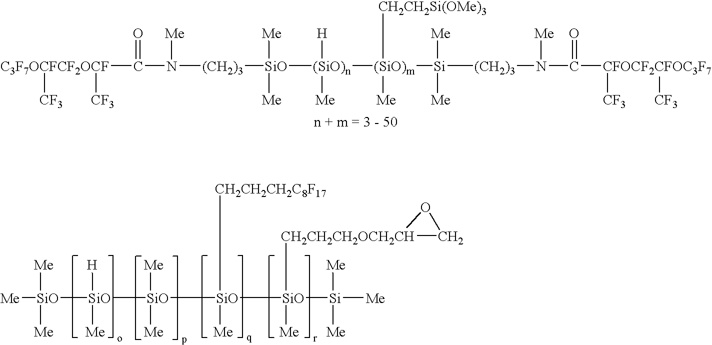
wherein o, q, r are positive integers and p is an integer of 0 or larger.

Component (E) is contained in the composition in an amount of preferably from 1 to 50 parts by mass, more preferably from 10 to 40 parts by mass per 100 parts by mass of Component (A). If the amount is below the aforesaid lower limit, sufficient adhesion strength may not be attained. Too much Component (E) may hinder curing and degrade fluidity of a composition, so that a cured product has low physical strength.

Instead of incorporating Component (E) in the composition, a substrate, to which the composition is to be applied, may be treated with a primer. Other adhesive promoters such as carboxylic acid anhydride, titanates and silane coupling agents may be incorporated, too.

Other additives include plasticizers, thickners, flexibilizers, retarder of hydrosilylation reaction, and inorganic fillers. These additives may be incorporated in the composition in such an amount that they do not adversely affect properties of the composition and a cured product thereof.

Examples of the plasticizers, thickners, flexibilizers include polyfluoro monoalkenyl compound of the following formula (8), linear polyfluoro compounds of the following formulas (9) and (10), and a mixture thereof.
Rf′-(X′)_{a′}CH═CH₂ (8)
wherein X′ is as defined above for the formula (2), a′ is 0 or 1, Rf′ is represented by the following formula: 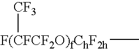
wherein f and h are as defined above, provided that a total of f and h is smaller than a total of m, n and r in the formula (1);
Z-O—(CF₂CF₂CF₂O)_{c}-Z (9)
wherein Z is a group of the formula C_{k′}F_{2k′+1}— with k′ being an integer of from 1 to 3, and c is an integer of from 1 to 200, provided that c is smaller than a total of m, n and r in the formula (1);
Z-O—(CF₂O)_{d}(CF₂CF₂O)ₑ-Z (10)
wherein Z is as defined above, d and e are integers of from 1 to 200, provided that a total of d and e is smaller than a total of m, n and r in the formula (1).

Examples of the polyfluoro monoalkenyl compound represented by the above formula (8) are as shown below, wherein m corresponds to f defined above.

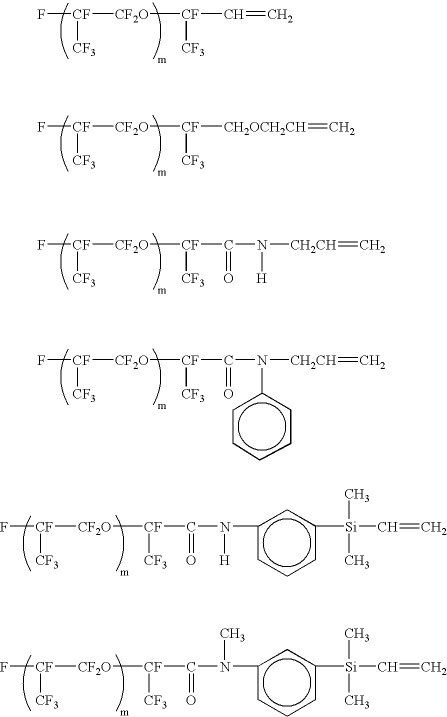

Examples of the linear polyfluoro compound represented by the formula (9) or (10) are as follows:
CF₃O—(CF₂CF₂CF₂O)_{c}—CF₂CF₃
CF₃—[(OCF₂)_{d}(OCF₂CF₂)ₑ]—O—CF₃

The polyfluoro compound of the formula (8), (9), or (10) may be incorporated in the composition in an amount of from 1 to 300 parts by mass, preferably 50 to 250 parts by mass, per 100 parts by mass of Component (A). The polyfluoro compound preferably has a viscosity of from 100 to 100,000 mPa·s at 23° C.

Examples of the retarder include acetylenic alcohol such as 1-ethynyl-1-hydroxycyclohexane, 3-methyl-1-butyne-3-ol, 3,5-dimethyl-hexyne-3-ol, 3-methyl-1-pentyne-3-ol, and phenylbutynol; a reaction product of the aforesaid chlorosilane having a monovalent fluorinated group with acetylenic alcohol; 3-methyl-e-pentene-1-yne, 3,5-dimethyl-3-hexene-1-yne, triallylisocyanurate, polyvinylsiloxane and organic phosphorous compounds. By containing the retarder, the composition can have a prolonged shelf life and a controlled reactivity.

Examples of the inorganic fillers include reinforcing fillers such as quartz powder, fused quartz powder, diatomaceous earth, and calcium carbonate; inorganic pigments such as titanium oxide, iron oxide, carbon black, and cobalt aluminate; fillers to improve heat-resistance such as titanium oxide, iron oxide, carbon black, cerium oxide, cerium hydroxide, zinc carbonate, magnesium carbonate, and manganese carbonate; fillers to increase heat conductance such as alumina, boron nitride, and silicon carbide; and fillers to attain electrical conductivity such as carbon black, silver powder and conductive zinc oxide.

The present invention also provides a method of preventing migration from a cured product of a composition comprising the fluoropolyether (A) by incorporating the aforesaid component (D) in the fluoropolyether (A). Preferably, the incorporation is performed by (i) blending at room temperature 100 parts by mass of Component (A) with 1 to 50 parts by mass of Component (D) in a blending apparatus such as a planetary mixer, a gate mixer, and then (ii) heating the blend prepared in the step (i) while continuing blending. Time of the blending in the step (i) and heat blending in step (ii) can be set as desired. Preferably, the blending in the step (i) is performed at least for 10 minutes and the heat blending in the step (ii) is performed at least for 1 hour. A temperature of the heat blending ranges from 100 to 200° C., preferably from 120 to 180° C. The heat blending may be performed at a reduced pressure, preferably of 100 mmHg or lower, more preferably of 50 mmHg or lower.

The blend of Components (A) and (D) thus obtained are mixed with Components (B) and (C), optionally Component (E) and other optional components, by using a mixing apparatus such as a planetary mixer and a gate mixer, or by using a kneading apparatus such as a kneader and a three-role mill. The mixing is performed preferably at a temperature of 40° C. or lower. The composition thus obtained gives a cured composition showing little migration.

The present composition can be cured at room temperature. Preferably, the composition is heated to promote curing at a temperature of 60° C. or higher, more preferably from 100 to 200° C., for a period of time of from several minutes to several hours.

The present composition may be used in a solution form dissolved in preferably a fluorinated solvent such as 1,3-bis(trifluoromethyl)benzene, Fluorinert, ex 3M Corp., perfluorobutyl methyl ether, or perfluorobutyl butyl ether. Particularly for thin film coating application, the solution is preferred.

The low-migrating property attained by the present composition or the method is particularly suitable for applications where cleanliness is required. For example, rubber parts made from the present composition is suitably used in manufacturing lines of electric or electronic parts such as FPC.

### EXAMPLES

The present invention will be explained with reference to the following Examples but not limited thereto. In the followings, “part” means part by mass. Viscosity was measured according to the Japanese Industrial Standards K6249 at 23° C.

### Example 1

In a planetary mixer, 100 parts of the polymer represented by the following formula (12) having a viscosity of 10,000 mPa·s and a vinyl group content of 0.012 mol/100 g was placed, to which 5.0 parts of fumed silica having 750×10¹⁸ silanol groups per gram, Aerosil A-300, ex Japan Aerosil Co. Ltd., was added and mixed for 10 minutes at room temperature. Then, heat was applied to the mixer, while mixing. After an internal temperature of the mixer reached to 150° C., the mixing was performed for another 1 hour at a reduced pressure of 30 mmHg at a temperature of from 150 to 160° C. Subsequently, the contents of the mixer was cooled to 40° C. or lower, to which 0.3 part of the fluorine-containing ethynyl compound of the following formula (13), 0.25 part of a solution of a platinum-divinyltetramethyldisiloxane complex in toluene with a platinum content of 0.5 mass %, and 17.5 parts of the fluorine-containing organohydrogensiloxane of the following formula (14) were added sequentially and mixed to be homogeneous. Then, the mixture was degassed at a reduced pressure of 30 mmHg and then passed through a three-roll mill for two times.

The composition obtained was cast in a 2-mm thick rectangular mold. It was press-curing at 150° C. for 10 minutes followed by curuing at 150° C. for 50 minutes and then at 200° C. for 4 hours in an oven. From the cured product, test pieces were cut out which were subjected to measurements of the properties shown in Table 1 according to the Japanese Industrial Standards K6251 and K6253.

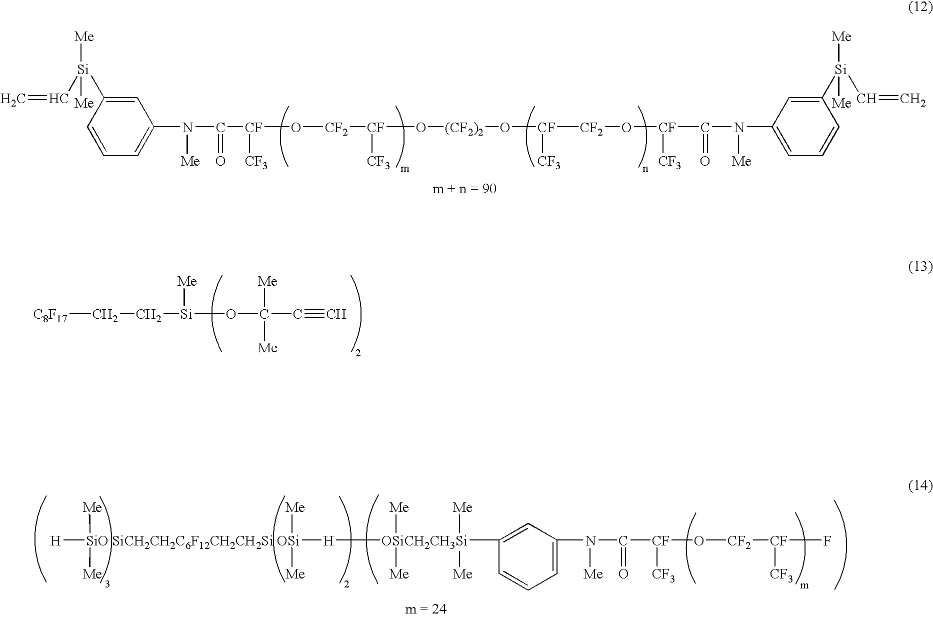

The following three tests were also performed to detect any migrated substances from the cured product.

Contact Angle Measurement

A clean silicon wafer with a dimension of 20 mm long by 20 mm wide was placed on a surface of the cured product at 25° C. prepared in Example 1. Five minutes later, the wafer was dismounted. On a surface of the wafer which surface had been in contact with the cured product, pure water was placed and a contact angle of the pure water to the surface of the wafer was measured. As a blank, a contact angle of pure water to another clean silicon wafer with the same dimension as the aforesaid wafer was measured. Results are as shown in Table 2.

ESCA Analysis of Silicon Wafer

A clean silicon wafer with a dimension of 20 mm long by 20 mm wide was placed on a surface of the cured product at 25° C. prepared in Example 1. Five minutes later, the wafer was dismounted. An area of 3 mm×10 mm with 5 nm in depth of a surface of the silicon wafer which surface had been in contact with the cured product was analyzed by Electron Spectroscopy Chemical Analysis (ESCA) at a detection angle of 45 degrees. As a blank, another clean silicon wafer with the same dimension was analyzed in the same manner as above. The results are as shown in Table 3.

Semi-Quantitative Analysis of Migrated Substances

A PET film having no coating with a surface treatment agent was placed on the cured product prepared in Example 1, on which a 20 g/cm² load was applied. After leaving for 24 hours, the PET film was peeled off from the cured product. Using an oily felt tip pen, the oily ink was applied to a 10 cm×10 cm area of the PET film surface which had been in contact with the cured product. Subsequently, the PET film was placed on a transparent graph paper with 1 mm scale. The number of grids not coated with the ink was counted and rated according to the following criteria.

A: The number of the grids was less than 10.

B: The number of the grids ranges from 10 to less than 20.

C: The number of the grids ranges from 20 to less than 30.

D: The number of the grids was 30 or more.

### Example 2

Example 1 was repeated except that Aerosil A-200 having 500×10¹⁸ silanol groups per gram, ex Japan Aerosil Co. Ltd., was used in place of Aerosil A-300. A cured product was obtained and evaluated in the same manner as in Example 1.

### Example 3

Example 1 was repeated except that a mixture of 4 parts of Aerosil A-130 having 325×10¹⁸ silanol groups per gram, ex Japan Aerosil Co. Ltd., and 1 part of Aerosil A-300 was used in place of 5 parts of Aerosil A-300. A cured product was obtained and evaluated in the same manner as in Example 1.

### Example 4

Example 1 was repeated except that 1.5 parts of organosiloxane represented by the following formula (15) was added after the fluorine-containing organohydrogensiloxane of the above formula (14) was added. A cured product was obtained and evaluated in the same manner as in Example 1.

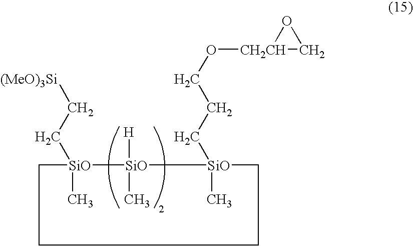

In this example, adhesive property of the composition was also evaluated according to the following method.

On an aluminum test panel with a dimension of 50 mm long by 25 mm wide, the composition prepared in Example 4 was applied in a layer of 0.08 mm in thickness at an end portion of the panel of 10 mm long by 25 mm wide. On the applied composition, an end portion of another aluminum test panel with the same dimension as the aforesaid panel was placed in such a manner that the two test panels forms a line with an overlapped area of 10 mm long by 25 mm wide sandwiching the composition therebetween. The panels were heated to 150° C. for 1 hour to cure the composition. The test piece thus obtained was subjected to a shear adhesion strength test at a pulling rate of 50 mm/min. After the test, a ratio of cohesive fracture was determined as an area % of the cured product remained adhered on the test panel to the originally applied area of 10 mm long by 25 mm wide. Results are as shown in Table 1.

### Referential Example 1

Example 1 was repeated except that 5 parts of Aerosil A-300 was blended at room temperature for 10 minutes and then for another 1 hour at a reduced pressure of 30 mmHg without heating. A cured product was obtained and evaluated in the same manner as in Example 1.

### Comparative Example 1

Example 1 was repeated except that Aerosil A-130 having 325×10¹⁸ silanol groups per gram, ex Japan Aerosil Co. Ltd., was used in place of Aerosil A-300. A cured product was obtained and evaluated in the same manner as in Example 1.

### Comparative Example 2

Example 1 was repeated except that Aerosil R-976 having 300×10¹⁸ silanol groups per gram, ex Japan Aerosil Co. Ltd., was used in place of Aerosil A-300. A cured product was obtained and evaluated in the same manner as in Example 1. Aerosil R-976 is manufactured by surface treating Aerosil A-300 with dichlorodimehtyl silane.

TABLE 1

| | | | | | Comp.^{*1} | Comp. | Ref.^{*2} |
|---|---|---|---|---|---|---|---|
| | Example | Example | Example | Example | Example | Example | Example |
| | 1 | 2 | 3 | 4 | 1 | 2 | 1 |
| Hardness, | 33 | 37 | 35 | 31 | 35 | 36 | 33 |
| Duro-A | | | | | | | |
| Tensile | 1.5 | 1.1 | 1.2 | 1.4 | 1.1 | 1.1 | 1.6 |
| strength, MPa | | | | | | | |
| Elongation | 180 | 150 | 150 | 150 | 140 | 130 | 190 |
| at break, % | | | | | | | |
| Shear | — | — | — | 1.8 | — | — | — |
| adhesion | | | | (100%) | | | |
| strength, MPa | | | | | | | |

^{*1}Comp. stands for Comparative.
^{*2}Ref. stands for Referential.

TABLE 2

| | | | | | | Comp. | Comp. | Ref. |
|---|---|---|---|---|---|---|---|---|
| | | Example | Example | Example | Example | Example | Example | Example |
| | Blank | 1 | 2 | 3 | 4 | 1 | 2 | 1 |
| Contact | 25 | 26 | 27 | 30 | 28 | 55 | 94 | 53 |
| angle, | | | | | | | | |
| degree | | | | | | | | |

TABLE 3

| | Elemental Composition, % | | | | |
|---|---|---|---|---|---|
| | Si | F | O | C | N |
| Blank | 44 | N.D. | 39 | 17 | N.D. |
| Example 1 | 44 | 1 | 38 | 17 | N.D. |
| Example 2 | 43 | 1 | 37 | 19 | N.D. |
| Example 3 | 43 | 2 | 36 | 19 | N.D. |
| Example 4 | 44 | 1 | 37 | 18 | N.D. |
| Comp. Example 1 | 40 | 8 | 35 | 17 | N.D. |
| Comp. Example 2 | 38 | 15 | 32 | 15 | N.D. |
| Ref. Example 1 | 40 | 8 | 36 | 16 | N.D. |

TABLE 4

| | | | | | Comp. | Comp. | Ref. |
|---|---|---|---|---|---|---|---|
| | Example | Example | Example | Example | Example | Example | Example |
| | 1 | 2 | 3 | 4 | 1 | 2 | 1 |
| Rating | A | A | A | A | C | D | C |

In Table 2, the contacts angles in Examples 1 to 4 are almost the same as that of the blank. In contrast, those in Comparative Examples are significantly larger than the blank. This indicates that the wafers were contaminated with some substances migrated from the cured products of Comparative Examples.

The contaminants were found to contain fluorine atoms as shown in Table 4. The fluorine-containing contaminants also repelled the oily ink. In contrast, no contamination was detected in Examples. Further, the cured products of Examples had mechanical properties as good as those of the cured products of Comparative Examples.

In Referential Example 1, the silica might not have been mixed homogeneously in the composition.

1. A composition comprising
100 parts by mass of (A) a linear fluoropolyether having at least two alkenyl groups,
(B) a fluorine-containing organohydrogensiloxane having at least two SiH bonds in such an amount that an amount of the SiH bonds ranges from 0.5 to 3.0 moles per mole of the alkenyl group of the Component (A),
(C) a platinum group metal compound in an amount of from 0.1 to 500 ppm calculated as the platinum group metal atom, and
1 to 50 parts by mass of (D) fumed silica having 350×10¹⁸/g or more of silanol groups on its surface.

2. The composition according to claim 1, wherein the fumed silica (D) has 500×10¹⁸/g or more of silanol groups.

3. The composition according to claim 1, wherein the composition further comprises 1 to 50 parts by mass of (E) an organosiloxane having at least one SiH group and at least one group selected from an epoxy and trialkoxysilyl groups, said one group selected from an epoxy and trialkoxysilyl groups being bonded to a silicon atom of the organosiloxane through an organic group which may have an oxygen atom.

4. The composition according to claim 1, wherein the linear fluoropolyether (A) has an alkenyl group content of 0.002 to 0.3 mol/100 g.

5. The composition according to claim 1, wherein the linear fluoropolyether (A) is represented by the following formula (1): 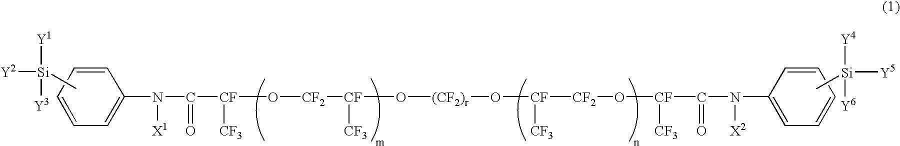
wherein each of X¹ and X² is a hydrogen atom, a methyl, phenyl or aryl group; each of Y¹, Y², Y³, Y⁴, Y⁵, and Y⁶ is a substituted or unsubstituted monovalent hydrocarbon group, at least two of Y¹, Y², Y³, Y⁴, Y⁵, and Y⁶ being alkenyl groups; r is an integer of from 2 to 6; and each of m and n is an integer of from 0 to 200.

6. The composition according to claim 1, wherein the fluorine-containing organohydrogensiloxane (B) has at least one group selected from a perfluoroalkyl, perfluorooxyalkyl, perfluoroalkylene, and perfluorooxyalkylene groups.

7. The composition according to claim 3, wherein the organosiloxane (E) has at least one group selected from a perfluoroalkyl and perfluorooxyalkyl groups bonded to a silicon atom of the organosiloxane through an organic group which may have an oxygen atom.

8. A method for preventing migration of a substance from a cured product of a composition to an object in contact with the cured product, wherein the composition comprises
(A) a linear fluoropolyether having at least two alkenyl groups,
(B) a fluorine-containing organohydrogensiloxane having at least two SiH bonds, and
(C) a platinum group metal compound
and said substance originates from the composition,
, said method comprising the step of blending 1 to 50 parts by mass of (D) fumed silica having 350×10¹⁸/g or more of silanol groups on its surface with 100 parts by mass of Component (A).

9. The method according to claim 8, wherein the step of blending comprises the steps of
(1) blending Component (A) with Component (D) at room temperature, and
(2) heating the blend prepared in the step (1) to a temperature of from 100° C. to 200° C. while blending.
